(19) United States
(12) Patent Application Publication
(10) Pub. No.: US 2007/0095670 A1
(43) Pub. Date: May 3, 2007

(54) ELECTROSTATIC FLUID TREATMENT APPARATUS AND METHOD

(76) Inventors: David McLachlan, Lenexa, KS (US); William Bridge, Overland Park, KS (US); Allen Wilson, Kansas City, MD (US)

Correspondence Address: SPENCER, FANE, BRITT & BROWNE, 1000 WALNUT STREET, SUITE 1400, KANSAS CITY, MO, 64106-2140, US

(21) Appl. No.: 11/608,109

(22) Filed: Dec. 7, 2006

Related U.S. Application Data
(62) Division of application No. 10/337,465, filed on Jan. 7, 2003.

(51) Int. Cl. B03C 5/02; C02F 1/469; B04B 5/10

(52) U.S. Cl. 204/551; 204/660

(57) ABSTRACT

A high voltage electrode and method of construction is provided including a multi-layered composition to optimize dielectric strength, dielectric constant, structural strength and durability. The high voltage electrode can be utilized as a submergible drop-in unit for easy installation within a fluid holding tank such as a water cooling tower. The submergible generator includes a channel that houses a charged electrode, and functions as a ground electrode to the charged electrode, and also functions as a fluid diverter.

### RELATED APPLICATIONS

The present patent application is a division and claims priority benefit of an earlier-filed non-provisional patent application of the same title, Ser. No. 10/337,465, filed Jan. 7, 2003. The identified earlier-filed patent application is hereby incorporated by reference herein.

### FIELD OF THE INVENTION

The present invention relates to the electrostatic treatment of fluids to enhance chemical reactions. More specifically, the present invention relates to improvements in electrostatic field generator apparatuses and electric fields in a fluid to increase the formation rate of small colloidal particles (crystalline).

### BACKGROUND OF THE INVENTION

Electrostatic treatment is used in aqueous and non-aqueous fluid such as process water treatment, petroleum based fluids and paint solids/water (detackification) mixtures. Electrostatic treatment is particularly useful for removal and prevention of scale deposits in water recirculating heat exchange systems. Scale formation is a single molecule by molecule process. Scale is formed in recirculating fluid systems, such as cooling towers for large buildings, when the recirculating water is subjected to temperature and pressure differentials. As the temperature of the water increases the minerals that are in solution (as ions) become less soluble allowing the minerals to precipitate out, forming scale. As the minerals in solution are precipitated they will tend to deposit on the higher temperature surfaces within the recirculating system causing adverse effects on the operation of the system. Deposited scale results in such operational disadvantages as reduced fluid flow, loss of heat transfer capability, decreased safety due to chemical treatments, increased corrosion and enhanced bio fouling.

For some time, electrostatic technology has been used to reduce the precipitation of mineral from solution (scale). An electric (also referred to as electrostatic) field is generated between a charged electrode and a ground electrode. The concentration of minerals in solutions is lowered through the formation of colloidal particles (in suspension) reducing the tendency for scale formation and increasing the ability of the fluid to dissolve existing scale deposits.

The creation of generally higher electric fields across a fluid being treated has been found to be more effective at preventing and removal of scale deposits, especially in connection with high volume recirculating systems. The electric field strength is directly proportional to the applied voltage to the charged electrode from the power source and inversely to the distance between the charged and grounded electrode. This relationship can be expressed by; E=V/d, where E is the electric field intensity, V is the applied voltage and d is the distance between the charged and grounded electrode. Thus, the electric field is increased by increasing voltage and hence increases the force on the positive and negative ions in solution, increasing the tendency for colloidal particle formation. It has been found that an electric field generated by an electrode operating around 30,000 volts DC or greater is significantly more efficient and effective for high-volume systems than an electrode operating at 10,000 volts DC.

In high flow, industrial fluid recirculating systems such as cooling towers, the toughness, mechanical strength and durability of the electrodes used to create the electric field within the fluid is very important. The charged electrode must be durable enough to protect the electrode from damage during installation and operation within the fluid system. Additionally, it is very important to design the charged electrode so that over its life it can withstand the applied voltage required to generate the electric field without voltage breakdown.

Prior to the instant invention, the charged electrodes of the prior art have been limited to either generally lower voltage (i.e. around 10,000 volts or less) higher durability electrodes, or generally higher voltage (i.e. around 30,000 volts or more) lower durability electrodes. An example of a lower voltage electrode is found in U.S. Pat. No. 4,545,887, issued to Arnesen et al. and incorporated herein by reference. Arnesen et al. discloses a charged electrode that includes a metal tubular layer that is encased in a thin layer of polytetrafluoroethane (PTFE, also known commercially under the registered trademark TEFLON). The metal tube provides a relatively rigid structure and acts as a conductor. The PTFE insulates the conductive tube to prevent a short when the electrode is submerged in fluid. PTFE is a relatively durable material which will resist considerable abuse during operation. Nevertheless, the layer of PTFE must be kept relatively thin because PTFE has a generally low dielectric constant (approx. 2.2), which decreases the electric field that can be generated across this insulating layer. The use of a relatively thin layer of PTFE reduces the dielectric strength of the electrode, thus reducing the maximum operating voltage of the electrode. Additionally, the thinner the layer of PTFE, the greater the potential vulnerability to puncture damage during installation and operation. It has been found that electrodes using PTFE as an insulation layer are not suitable for efficient and dependable operation at voltages higher than approximately 10,000 volts, beyond which they quickly experience breakdowns.

U.S. Pat. No. 5,591,317, issued to Pitts, Jr. and incorporated herein by reference, discloses a charged electrode that is capable of operation at higher voltages (around 30,000 volts). This electrode includes a non-structural conductive layer surrounded by a structural insulation layer that is constructed of a vitreous ceramic having a generally high dielectric constant (approx. 9 or higher). Because of its relatively high dielectric constant, Pitts' insulation layer could be made thicker than the insulation layer of PTFE without sacrificing electric field strength. While this was an improvement over the lower voltage electrodes of the prior art, the use of a more brittle vitreous ceramic insulation layer presents several disadvantages during installation and operation of the electrode. A sufficient impact on the exterior of the electrode of Pitts, as is quite common during installation, will result in damage to the insulation layer that will render the electrode useless. Additionally, breakage of the electrode during operation can dislodge pieces of the ceramic material, blocking fluid flow and causing damage to pumps, valves, heat exchangers, or other components of a fluid system.

Therefore, in light of the disadvantages of the prior art, it would be beneficial to provide a charged electrode that is durable, and which can withstand a generally high operating voltage.

Generally, the charged electrodes of the prior art have been tubular shapes. This tubular shape generates a non-uniform electric field that at best decreases with the inverse of the distance from the tubular surface. Additionally, the tubular shape limits the total available active surface area and hence the size of the electric field that can be applied to the fluid. Therefore, it would be beneficial to provide an electrode that generates a larger and more uniform electric field with a higher intensity while maximizing the fluid flow that passes through said electric field. In doing so, the effective contact or dwell time would be increased.

Most of the electrodes of the prior art have been designed to be direct inserts, which are installed into an electrically grounded metal pipe through which the fluid flows. In a cooling system, the direct insert location will be in a pipe through which the fluid exits or enters a device such as a cooling tower. Use of a direct insert installation requires significant downtime of the fluid system while the electrode is installed. The pipe must be drained and cut open by a professional welder and fitted with a socket to support the electrode. Such an installation can take up to eight hours for a single electrode. Such long down times are very disruptive and often requires that installation be made during cooler months or during period in which the system can be shut down. Furthermore, the use of a direct insert electrode limits the overall size of the electrode that can be used due to the limited dimensions of the pipe and flow restrictions created by the insertion of the electrode.

Several electrodes of the prior art have been installed within the fluid holding tank (or water cooling tower) of the fluid recirculating system. Such an installation can significantly reduce installation time for the electrodes. Nevertheless, it is usually still necessary to cut a hole in the holding tank and insert a socket for supporting the electrode or else utilize a preexisting socket within the holding tank. This is because the electrodes of the prior art often lack sufficient water-excluding properties to be entirely submerged in the fluid. Usually, one end of the electrode is closed, and another end is open to connect the electrode to a power source through a wire.

Submergible electrodes of the prior art have been inserted into electrically grounded fluid holding tanks without the need of adding new supporting sockets. Although installation of an electrode within a grounded holding tank does increase the volume of water that is subjected to the electric field, it does not provide adequate fluid contact time nor sufficient electric field intensity due to large separation distances (i.e., size of tank) to be effective at reducing scale formation. Other prior art electrostatic generators have included a separate ground electrode (or other metal object) within the holding tank. The use of a separate ground electrode does increase the effectiveness of the electric field; however, the prior art installations do not attempt to increase the dwell time at a single location within the holding tank. Instead the installations of the prior art require placement of multiple charged electrodes at numerous strategic locations throughout a holding tank to ensure that all of the fluid is exposed to an electric field.

Therefore, it would be beneficial to provide an electrostatic charge generator that can be inserted (dropped) into a fluid holding tank or water cooling tower without the need for significant down-time. Additionally it would be beneficial to provide such a drop-in electrostatic charge generator that can be installed at a single location within a holding tank and still provide adequate dwell time and exposure of all fluid within the recirculating system to an electrostatic charge.

### SUMMARY OF THE INVENTION

A principal object of the instant invention is to provide an electrostatic charge generator for use in high volume, large-scale, fluid treatment systems. Another object of the instant invention is to provide a high voltage (about 30,000 volts or higher) electrode that has good toughness, strength and durability. Yet another object of the instant invention is to provide a high voltage electrode that will lower installation costs, operational costs and also increase efficiency. Another object of the instant invention is to provide an electrode composition that allows for various physical, chemical and electrical characteristics to improve overall performance, reliability and design flexibility.

The above objectives are accomplished through the use of a multi-layered composition for a charged electrode. The different layers used in the construction of the inventive electrode are selected to maximize the electrical, chemical, and/or mechanical characteristics of each material for its intended use. The various components of the electrode composite structure are selected based on the shape of the electrode and the environment (temperature, fluid flow rate, turbulence, fluid type, total volume, space restriction, etc.) in to which the electrode is to be placed. The combination of both the electrode design and the materials used results in double or triple electrical and chemical encapsulation while giving enhanced mechanical characteristics.

The electrode of the instant invention includes a central structural component (or layer), a conductive layer bonded to the structural component, and an insulation layer bonded to the conductive layer. In the preferred embodiment, an additional protective layer is included as an outer-most layer of the electrode. This multi-layered construction allows for a wide variety of physical, chemical and electrical characteristics to be combined together in a single electrode, allowing for increased design flexibility. The multi-layered composition provides a highly durable and reliable electrode that is structurally robust and can be operated at high voltages.

The multi-layered composition of the instant invention can be used to manufacture an electrode of virtually any shape and size, increasing the overall application flexibility, as well as, the durability and effectiveness of the electrode. The electrode of the instant invention can be designed as a tubular electrode similar to the electrodes of the prior art; however, the inventive electrode may also be curved to fit any desired application. The inventive electrode can be either flexible or rigid. A plate design can be utilized to maximize the active surface area of the electrode, allowing for a more uniform electric field between the charged and ground electrodes. The plate electrodes are generally flat shapes and can be a curved, or virtually any other shape desired. The shape of the plate electrode can be designed to channel the fluid as well as minimize the flow restrictions across the surface of the electrode for virtually any desired application.

The structural layer of the instant invention provides rigidity, toughness, durability and mass to the electrode. The structural layer allows materials having less desirable structural characteristics to be utilized as conductive and insulating layers for the electrode without sacrificing durability. For example, a relatively brittle insulation layer can be utilized having a generally high dielectric constant and dielectric strength. Impacts during installation and highly turbulent operating conditions will not result in damage to the insulation layer due to the increased strength and rigidity added by the structural layer. The additional mass of the structural layer can be utilized to counteract stresses caused by buoyancy of the electrode in the fluid. The overall size of electrodes can be increased because of their increased structural support.

The multi-layered electrode of the instant invention can be manufactured, installed and maintained at a significantly lower cost than the electrodes of the prior art. Designed for manufacturability utilizing commercially available materials, assembled with the innovative use of dedicated fixturing, vacuum clamping, and special surface preparation results in high yields and a very robust, high quality product. Further savings are gained through the use of standardized design components having a high degree of application flexibility.

Another object of the instant invention is to provide an electrostatic charge generator that can be easily installed within a fluid recirculating system without the need for extensive down time of the recirculating system.

Yet another object of the instant invention is to provide an electrostatic charge generator that maximizes dwell time and exposure of a fluid to an electric field. Another object of the instant invention is to provide an electrostatic charge generator that maximizes dwell time and exposure of a fluid to an electric field while minimizing back-pressure and increasing flow volume.

The above objectives are accomplished through the use of a “drop-in” electrostatic charge generator. The drop-in unit includes a charged electrode that is located within a grounded fluid diverting channel. The fluid diverting channel is designed to be placed near a drain or other fluid exit located such that at least a large portion of the fluid must pass through the channel to exit the holding tank. Thus, the channel acts to divert the fluid across the surface of the charged electrode located within the channel, resulting in increased exposure and or dwell time. The use of a drop-in unit allows for quick installation, as no pipes need to be cut and mounting sockets do not need to be installed.

In the preferred embodiment of the fluid diverting channel, the channel also acts as a ground electrode for the charged electrode located within the channel. The shape and size of the channel can be arranged to correspond to the shape of the surface electrode and to control and optimize the shape and intensity of the electric field created between the charged electrode and the grounded channel. Multiple channels, each containing a separate charged electrode, can be combined into a single unit fluid diverting channel. Such a design is especially beneficial to increase dwell time in high flow applications while reducing back-pressure. Each channel or chamber of a multiple channel unit will have an isolated electric field that will result in better efficiency and effectiveness than using a single larger channel.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a cross-sectional view taken along line 1-1 of FIG. 12 showing a first embodiment of a plate electrode incorporating the layered composition of the instant invention.

FIG. 2 is a cross-sectional view taken along line 1-1 of FIG. 12 showing a second embodiment of a plate electrode incorporating the layered composition of the instant invention.

FIG. 3 is a sectional view taken along line 3-3 of FIG. 12 showing an electrical connection of the first embodiment of the layered plate electrode from FIG. 1.

FIG. 4 is a sectional view taken along line 4-4 of FIG. 12 showing an isolation frame of the first embodiment of the layered plate electrode from FIG. 1.

FIG. 5 is a perspective view of a tubular electrode incorporating the layered composition of the instant invention.

FIG. 6 is a cross-sectional view taken along line 6-6 of FIG. 5 showing the layered composition of the tubular electrode of FIG. 5.

FIG. 7 is a sectional view of area 7 of FIG. 5 showing a sealed closed-end portion of the tubular electrode.

FIG. 8 is a partial cut-away view of area 8 of FIG. 5 showing a sealed electrical connection end portion of the tubular electrode.

FIG. 9 is a perspective view of a first embodiment of a fluid-diverting channel of the instant invention for providing transverse flow of a fluid across a charged electrode.

FIG. 10 is a perspective view of a second embodiment of a fluid-diverting channel of the instant invention for providing longitudinal flow of a fluid across a charged electrode.

FIG. 11 is a partial perspective view of a third embodiment of a fluid-diverting channel of the instant invention including a trough for maintaining a minimum fluid level around a charged electrode.

FIG. 12 is a perspective view of a plate electrode incorporating the layered composition of the instant invention.

FIG. 13 is a perspective view of a drop-in fluid-diverting channel arrangement of the instant invention for placement on the floor of a water cooling tower.

### DESCRIPTION OF THE PREFERRED EMBODIMENTS

Preferred embodiments of the present invention are hereinafter described with reference to the accompanying drawings.

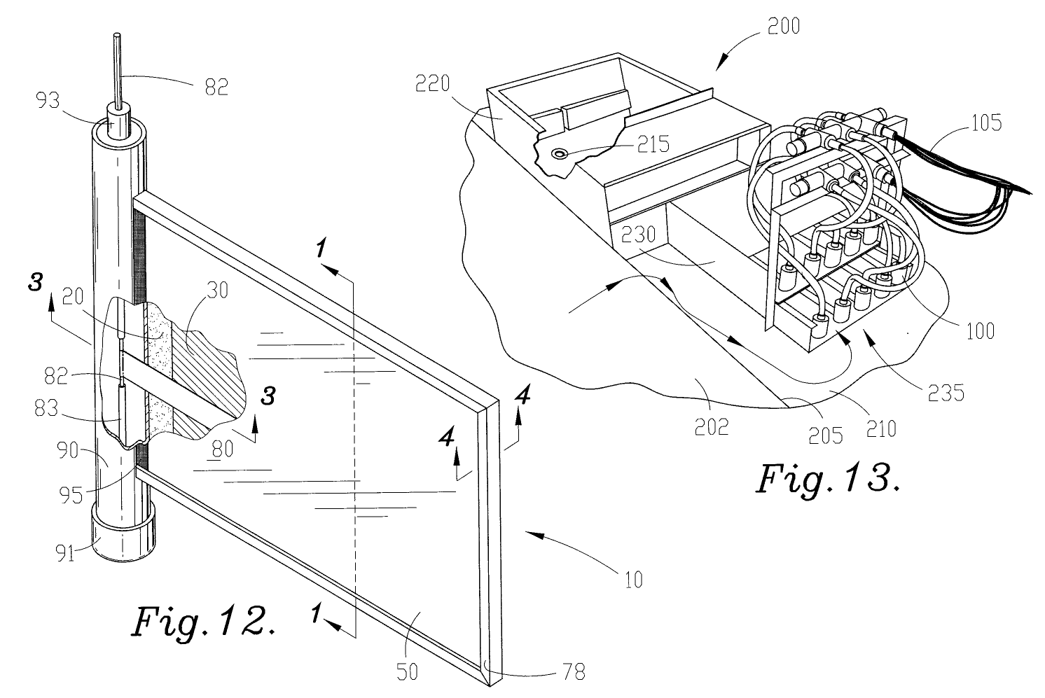

Referring to FIG. 12 a perspective view of a preferred embodiment of the multi-layered electrode of the instant invention in the form of a plate. The plate electrode shown in the instant invention has been designed to have a generally flat shape. Nevertheless other shapes, such as a curved shape can be utilized to provide a more uniform electric field or to optimize fluid flow characteristics (i.e. increase dwell time and/or decrease back-pressure) of the plate for use in numerous possible applications.

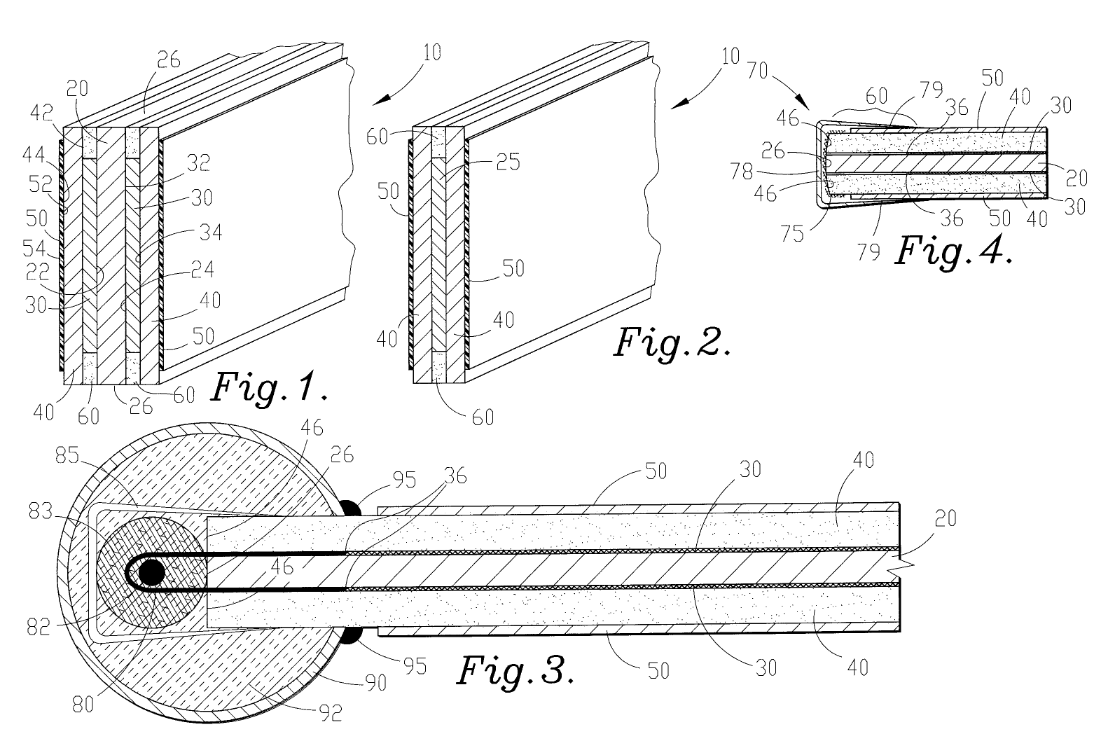

FIGS. 1 & 2 show two alternative embodiments of the construction of the flat plate electrode shown in FIG. 12. In FIGS. 1 & 2, portions of isolation frame 70 (discussed below with respect to FIG. 4) have been excluded for clarity. FIGS. 1 & 2 are cross-sectional views of the flat plate electrode of FIG. 12 taken along cross-section line 1-1. In FIG. 1 plate electrode 10 includes structural support layer 20 as a first layer located within the middle of the plate electrode. Structural support layer 20 is shown as a generally flat layer having outer surfaces 22 and 24 and perimeter edges 26. Structural support 20 is of sufficient thickness to add strength and rigidity to electrode 10. Structural support 20 can be made from polymer composite metal or any other suitable material.

The embodiment of plate 10 shown in FIG. 1 includes a conductive layer 30 bonded to each of outer surfaces 22 and 24 of structural support 20. Conductive layer 30 includes inner surface 32 which is placed in intimate contact with the outer surface of structural support layer 20. Conductive layer 30 can be made of a conductive polymer, a conductive thick or thin film, a conductive metal or any other suitable conductive material.

Plate electrode 10 as shown in FIG. 1 includes an insulation layer, 40, bonded to the outer surface of each of conductive layers 30. Insulation layer 40 includes inner surface 42 which is placed in intimate contact with outer surface 34 of conductive layer 30 and outer surface 44 which is directly opposed to inner surface 42. The insulation layer is chosen from materials having a generally high dielectric strength to contain the high electrical potential (voltage) that is applied to electrode 10 to create the electric field. Additionally, the materials for manufacturing the insulation layer will be chosen from materials having a generally high dielectric constant to assist in establishing the creation of a strong electric field being generated by electrode 10. Insulation layer 40 can be made of either a single material, layered material or composite material, including polymers, ceramics, glass or any other suitable material.

The outer surface of each insulation layer 40 includes protective layer 50 that is utilized to enhance the chemical inertness of the electrode and/or to make the electrode more durable to impacts. Protective layer 50 has inner surface 52 which is bonded to outer surface 44 of the insulation layer. Outer surface 54 of protective layer 50 will be in contact with the fluid in which electrode 10 is submerged. This protective layer can be composed of a polymer, a metallic ceramic, glass or any other suitable material.

FIG. 2 shows an alternative embodiment of the layered plate electrode shown in FIG. 12 wherein the structural support layer and the conductive layers discussed above are composed of a single material that provides both the structural element function and the conductive element function. In FIG. 2 conductor support layer 25 is the central layer of the plate electrode and includes two outer surfaces and a perimeter edge. As is discussed with respect to the embodiment shown in FIG. 1, insulation layers 40 are bonded to the outer surfaces of conductor support layer 25. Additionally as is described above with respect to FIG. 1, protective layer 50 is bonded to the outer surfaces of insulation layers 40.

Because of the high voltage (approx. 30,000 volts or higher) that will be applied to the conductive layers of the instant invention, it is very important to provide appropriate insulation between the conductive layers and the fluid in which the electrode will be submerged to prevent malfunction of the electrode. The thickness of insulation layers 40 should be sufficient to contain the electrical potential created along the outer surfaces of the conductive layers. Additionally, it is important to provide insulation around the perimeter edges of conductive layers to contain the electrical potential that is created along those edges. FIGS. 1 & 2 both show the creation of insulating borders 60 around the perimeter edges of the conductive layers. In FIG. 1 insulation layers 40 and structural support layer 20 have perimeter edges that extend beyond the perimeter edges of the conductive layers 30. Border 60 is located between the inner surface of insulation 40 and the outer surfaces of structural support layer 20 to surround the outer perimeter of each of the conductors. Border 60 can be composed of the same insulating material as is insulation layer 40. Additionally, insulation layers 40 and structural layer 20 both might be composed of the same insulating material and then bonded together by an appropriate adhesive to create border 60 around the perimeter edges of the conductive layers.

The multiple layers of the plate embodiment of the instant invention can be constructed through the use of an innovative process, in which the individual layers are assembled together and subjected to a reduced pressure atmosphere (i.e. a vacuum) to compress the multiple layers into a single unit. A bonding compound is applied to the surfaces of the layers. For example a bounding compound, such as an insulating glue is applied to the outer surfaces of the structural layer. A conductive layer is then placed in contact with the bonding compound that has been applied to each outer surface of the structural layer. Additional bonding compound is then applied to the outer surface of each conductive layer, and the inner surface of an insulating layer is placed in contact with the bonding compound on the outer surface of the conductive layer. This layered unit is then inserted into a sealed flexible container, and a vacuum is applied to reduce the pressure in the container. The reduced pressure within the container will cause the flexible container to collapse tightly around the surface. The pressure differential created by the lower pressure within the container and the higher atmospheric pressure outside the container will provide a uniform compressive force along the entire surface of flexible container and thus provide a uniform compressive force along the entire surface of the layered unit. The compressive force results in the elimination of air pockets within the bonding compound between the individual layers.

As additional insulation, the plate electrode of the preferred embodiment of the instant invention includes a perimeter isolation frame in which border 60 is one of three levels of protection to prevent a short between the high voltage potential of the conductive layers and the fluid in which the electrode is submerged. FIG. 4 shows a sectional view of plate electrode 10 taken along section line 4-4 of FIG. 12 to show the three part isolation frame of the instant invention.

FIG. 4 shows the preferred embodiment of isolation frame 70 as it exists with respect to the layered plate electrode discussed in FIG. 1 above. As discussed with respect to FIG. 1, plate electrode 10 includes central structural support layer 20, conductive layers 30 located along the outer surfaces of structural layer 20 and insulation layers 40 located along the outer surface of each of the conductive layers. Additionally, as discussed with respect to FIG. 1, protective layer 50 is located along the outer surface of each of the insulation layers.

Isolation frame 70 includes border 60 which is constructed to extend beyond perimeter edge 36 of conductive layer 30. As discussed above with respect to FIG. 1, perimeter edges 46 of the insulation layers and perimeter edge 26 of the structural support layer extend beyond perimeter edges 36 of the conductive layers. The portions of the insulation layers that extend beyond the perimeter edges of the conductive layers are each bonded to the outer surfaces of the structural support layer by an insulating adhesive to form border 60. In the preferred embodiment the structural support layer is made of an insulating material so that the border created around the perimeter edge of the conductive layers by bonding together the insulation layer and the structural layer will be sufficient to prevent the high voltage conductive layer from shorting out to the fluid surrounding the electrode.

A second component of isolation frame 70 includes a sealant layer 75 applied to perimeter edges 46 of the insulation layers and perimeter edge 26 of the structural support layer. The sealant layer can be silicon or any other suitable sealant that will assist in preventing the fluid from penetrating into electrode 10.

A third component of isolation frame 70 includes a protective band, 78, that wraps around the perimeter edge of electrode 10. Band 78 is formed of a single piece of material that is wrapped around and glued to the perimeter edge of the electrode in such a manner that edges 79 of the band extend over a portion of the outer surfaces of protective layers 50. Such a band arrangement will work both to prevent damage to the edge of electrode 10 and to assist in mechanically securing the protective layers to the outer surfaces of the insulation layers.

FIG. 3 shows an electrical connection for providing a fluid-tight or fluid excluding electrical connection between the conductive layers of the plate electrode of the instant invention and a high voltage power source. FIG. 3 is a sectional view taken along line 3-3 of the plate electrode of FIG. 12. FIG. 3 shows the electrical connection for the layered plate electrode of the embodiment discussed in FIG. 1 above. As is discussed in FIG. 1, plate electrode 10 includes structural support layer 20, conductive layers 30 bonded to opposing outer surfaces of the structural support layer, an insulation layer, 40, bonded to the outer surface of each conductive layer, and a protective layer, 50, bonded to the outer surface of each insulation layer 40.

Perimeter edge 26 of the structural support layer and perimeter edges 46 of each of the insulation layers extend beyond perimeter edge 36 of each of the conductive layers. A conductive tape, 80, is electrically connected to conductive layer 30 and extends beyond outer perimeter 36 of each conductive layer between structural support layer 20 and insulation layer 40. Conductive tape 80 continues beyond the perimeter edges of the insulation layer and the structural layer and makes electrical contact with wire conductor 82 located near the perimeter edge of electrode 10. In the preferred embodiment, conductive tape 80 is soldered to the conductive wire 82 to provide for the electrical connection between those two components; however any other suitable connection can be utilized.

Insulating cap 85 is glued in place to surround wire conductor 82 and the perimeter edges of the insulation layers to assist in providing a fluid-tight electrical connection. Additionally a protective insulating jacket, such as a PVC tube, is wrapped around the wire conductor and the perimeter edge of the electrode 10 to provide an additional fluid barrier around the electrical connection. Jacket 90 is connected to insulation layer 40 by weld 95 to increase the fluid tight integrity of the electrical connection. Wire conductor 82 is encased in electrical potting compound 92 that fills the interior of jacket 90. The electrical potting compound provides yet another level of protection to prevent fluid from coming in contact with any electrically conductive materials within electrode 10.

FIG. 12 shows, in cutaway view, the electrical connection described above with respect to FIG. 3. As shown in FIG. 12, conductive tape 80 does not need to extend across the entire surface of conductive layer 30. Instead, a single connection point can be provided at any location along conductive layer 30. Thus, wire conductor 82 only needs to be exposed at the point of connection to the conductive tape. The remainder of wire conductor 82, which is not in electrical connection with conductive tape 80, includes the original wire insulation, 83, around the conductor to provide yet another level of protection from short circuits.

Jacket 90, shown in FIG. 12, extends along an entire perimeter edge of electrode 10. One end of jacket 90 is sealed with cap 91 to provide a fluid-tight connection at that point. Wire conductor 82, and its insulating sheath, 83, extends from the interior of jacket 90 to the exterior of jacket 90, and eventually to a power source, through an open end of the jacket that opposes sealed cap 91. The open end of jacket 90, through which the wire exits the jacket, includes a water-tight sealant, 93, such as silicon or some other suitable material to prevent fluids from entering jacket 90 while the electrode is submerged.

Although jacket 90 is shown covering an entire perimeter edge of electrode 10, it is possible to construct the electrical connection in such a way that the jacket is only located along a portion of the perimeter edge of the electrode. Additionally, a single component electrical connection could be constructed utilizing a molded compound.

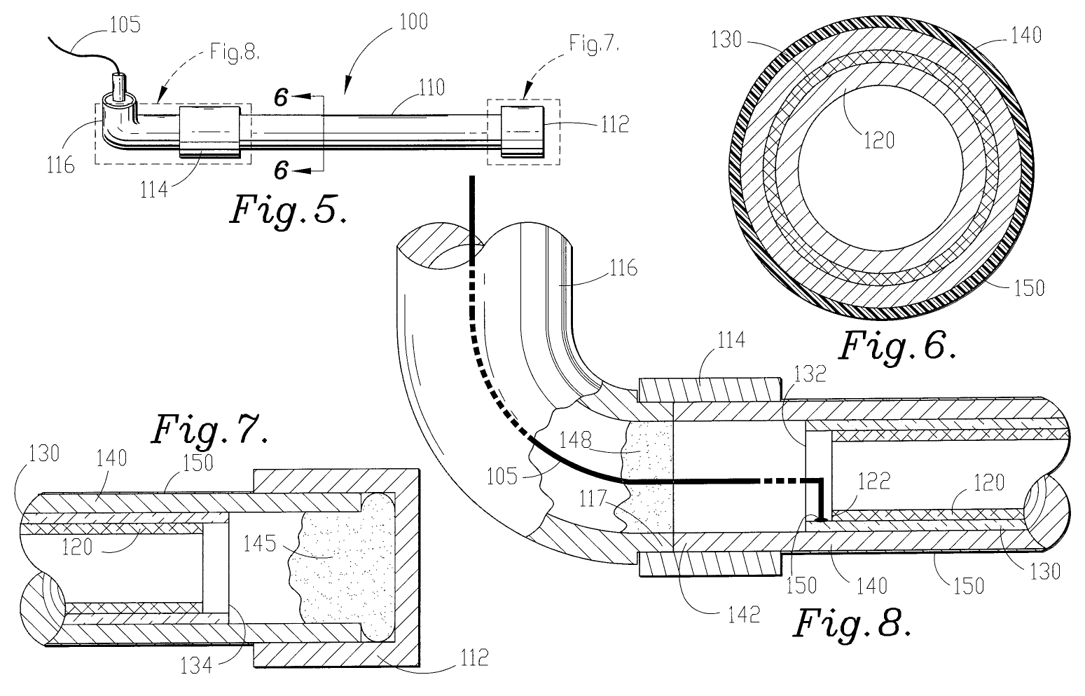

FIGS. 5 through 8 show an alternative embodiment of the instant invention in which the electrode has a tubular shape. FIG. 5 shows a perspective view of tubular electrode 100. Tubular electrode 100 includes tubular main body section 110, end cap 112 connected to one end of tubular main body section 110, and collar 114 connecting the other end of tubular main body section 110 to a transition section, 116. Electrical power supply wire 105 extends from a high voltage power source and into transition section 116 of electrode 100 to make an electrical connection to the electrode. The outer end of transition section 116 is sealed with a suitable sealant such as silicon to make a fluid-tight connection around power wire 105 at its point of entry into transition section 116.

FIG. 6 shows a cross-section of main body 110 of electrode 100 taken along line 6-6 from FIG. 5. FIG. 6 shows the layered composition of the main body of electrode 100. Electrode 100 includes structural layer 120, conductive layer 130, insulation layer 140 and protective layer 150. Structural layer 120 is the inner-most layer of main body 110. As described in connection with the plate electrode embodiment of the instant invention, the structural layer increases the mechanical integrity of the electrode by adding strength, mass, rigidity and flexibility as needed. The structural layer can be a metal, plastic, composite, or any other suitable material. The use of the structural layer allows for an increased length of tubular electrodes while minimizing the need for external support and provides electrode integrity under rough operating and installation conditions.

A tubular conductive layer 130 is bonded to the outer surface of structural layer 120, as is shown in FIG. 6. Conductive layer 130 is connected to power line 105 and provides for the even distribution of electrical charge across the entire surface of the tubular electrode. The conductive layer may be composed of a metallic material, thick or thin conductive film, a conductive polymer, or any other suitable conductive material.

As is shown in FIG. 6, tubular insulation layer 140 is bonded to the outer surface of conductive layer 130. As has been discussed in connection with the plate electrode above, the insulation layer encloses and isolates the conductive layer from the fluid in which the electrode is submerged. The insulation layer may be composed of any suitable material having a generally high dielectric strength and a generally high dielectric constant including polymers, ceramics, glasses, singular or layered materials, composites, or any other suitable material. In the preferred embodiment illustrated in FIGS. 5 through 8, insulating layer 140 is composed of PVC tubing materials.

FIG. 6 shows the inclusion of an outer protective tubular layer that is bonded to the outer surface of insulation layer 140. Outer protective layer 150 functions to provide chemical inertness of the electrode and to assist in maintaining the structural integrity of the insulation layer during impact. The impact resistance property of the protective layer enhances the robustness of the electrode structure to prevent damage during installation and as needed in high turbulent conditions. Polymers, composites, or other suitable materials may be utilized to provide impact resistance. Polymers, glasses, metallic foils or other suitable coatings can be used to provide for chemical inertness. The protective layer may be a single layer or may be composed of multiple layers to provide the desirable protective characteristics.

It is appreciated that the same materials and methods of manufacturing discussed above, and/or utilized, in connection with the tubular embodiment of the multi-layered electrode can be utilized in connection with the plate embodiment of the electrode. Additionally, any materials and methods of manufacturing discussed above, and/or utilized in connection with the plate embodiment of the electrode can be utilized in connection with the tubular embodiment.

FIG. 7 shows a cross-sectional view of the closed end section of electrode 100 shown in area 7 of FIG. 5. As is shown, in FIG. 7 insulating layer 140 will extend beyond end 134 of conductive layer for 130. Additionally, if structural layer 120 is composed of a conductive material such as metal, it will be beneficial to have insulating layer 140 also extend beyond the end of the structural layer, as is shown in FIG. 7. End cap 112, composed of an insulating material, is then sealed to insulating layer 140 to provide a water-tight connection. If desired, insulating end cap 112 can also be sealed to, and/or overlap (not shown), protective layer 150 to increase the overall structural integrity of electrode 100. An adhesive plug, 145 is included within end cap 112 and the end of main body 110 to provide an additional level of insulation and water-tight protection.

FIG. 8 shows the end of electrode 100 opposing sealed end cap 112. This open end section provides the electrical connection of electrode 100 to the power source. FIG. 8 shows the open end electrical connection end of electrode 100 shown in area 8 of FIG. 5. A cutaway portion of FIG. 8 shows a cross-sectional view of electrode 100. As is seen in FIG. 8, end 132 of conductive tubular layer 130 extends beyond end 122 of tubular structural layer 120. Power wire 105 is soldered at solder point 150 to conductive layer 130. Solder point 150 is located between end 132 of conductive layer 130 and end 122 of structural layer 120. Insulating layer 140 extends beyond solder point 150 and conductive end 132 into union collar 114 and terminates at insulator end 142. Insulator end 142 abuts against transition end 117 within union collar 114. Union collar 114 provides a water tight connection between transition 116 and insulating tubular layer 140. An insulating seal plug, 148, is located within transition section 116. Insulating seal plug 148 allows wire 105 to pass through transition 116 and make contact with solder point 150 while providing a water-tight connection between conductive layer 130 and transition 116.

As it applies to the multiple layers of the electrodes of the instant invention, whether tubular, plate or otherwise, the term “bonded,” “bonding,” or “bond” or any other variation thereof, is intended to refer to any suitable means for maintaining the multiple layers in close contact with each other and thus holding the electrode together. A bond can be composed of a glue or cement or other suitable compound. Alternatively a bond could simply refer to frictional or other similar forces that maintain the close contact between the layers. For example, the conductive layer could simply be sandwiched between the structural layer and the insulation layer without the use of any glue, cement or other bonding agent directly connecting the conductive layer to either the insulating layer or the structural layer. The “bond” could even be the result of a clamping force that holds two layers together, or simply a generally close frictional fit between two layers.

FIG. 13 shows one embodiment of the drop-in electrostatic charge generator of the instant invention that may be located within a recirculating fluid system such as a water cooling tower for a large building. In FIG. 13, a drop-in electrostatic charge generator, 200, is shown located at the bottom of a water cooling tank (not shown). In this particular embodiment, the water cooling tank includes a floor having an elevated shelf 202 ending at ledge 205 which drops off to lower floor 210. Drain 215 is located within lower floor 210 to allow water that has been cooled by the water cooling tower through evaporation to exit the cooling tower and flow through the heat exchanger located within the building air conditioning system. As the water flows through the heat exchanger within the building air conditioning system, the water will be heated and directed back into the top of the cooling tower to go through the evaporation process. As the water flows down through the cooling tower evaporators, it will flow across shelf 202 toward ledge 205 and then over ledge 205 down to floor 210 and eventually into drain 215 to complete the re-circulation.

In the embodiment shown in FIG. 13 of the instant invention, fluid diverter 220 is placed over drain 215 to redirect the flow of the water before it exits the water cooling tower through drain 215. Fluid diverter 220 is a structure having walls that extend from floor 210 to a height of sufficiently above shelf 202 to enclose drain 215 and prevent the majority of the water flowing through the recirculating system from entering drain 215 before it is redirected through the electrostatic generator of the instant invention. The water is diverted by fluid diverter 220 to channel opening 235 located at one end of channel 230. Channel 230 can be any shape and contains at least one tubular charged electrode 100 which is connected to power supply 105. Channel 230 is also connected to power supply 105 as a ground. Channel 230, in the embodiment shown in FIG. 13, includes multiple walls separating each of the individual electrodes 100. The walls also are connected to the ground of power supply 105 enabling the walls to isolate each individual electrode such that the electric field of each individual electrode 100 is contained within the walls surrounding that electrode. The positioning of the walls within channel 230 and the shape of each individual chamber surrounding each electrode 100 can be adjusted to control the electric field strength and shape generated between each charged electrode 100 and the ground electrode created by the grounded walls of channel 230. Once the fluid flows through channel 230 and has been subjected to the electric field generated within channel 230 between the charged electrodes 100 and the grounded walls of channel 230, the fluid will exit channel 230 at a point within fluid diverter 220 which surrounds, is connected to, or in the vicinity of, drain 215. The fluid can then continue its path through drain 215 and into the heat exchanger of the building air conditioning system, and the re-circulation process can continue.

It will be appreciated that either a tubular charged electrode, or a flat plate electrode or any other shape of charged electrode, whether or not a multi-layered electrode as described in connection with the instant invention, can be utilized in connection with drop-in electrostatic generator 200 shown in FIG. 13. Additionally, it will be appreciated that the size and shape of fluid diverter 220 and channel 230 may be altered significantly to allow drop-in 200 to be utilized in a variety of re-circulating fluid systems and to control electric field intensity and fluid dwell time. In some instances, the use of a separate fluid diverter 220 and channel 230 may be unnecessary depending upon the layout of the cooling tower or holding tank. In such a situation, the placement of channel 230 will be such that the fluid (or at least a large proportion of the fluid) must flow through channel 230 before reaching drain 215, and channel 230 is also the fluid diverter.

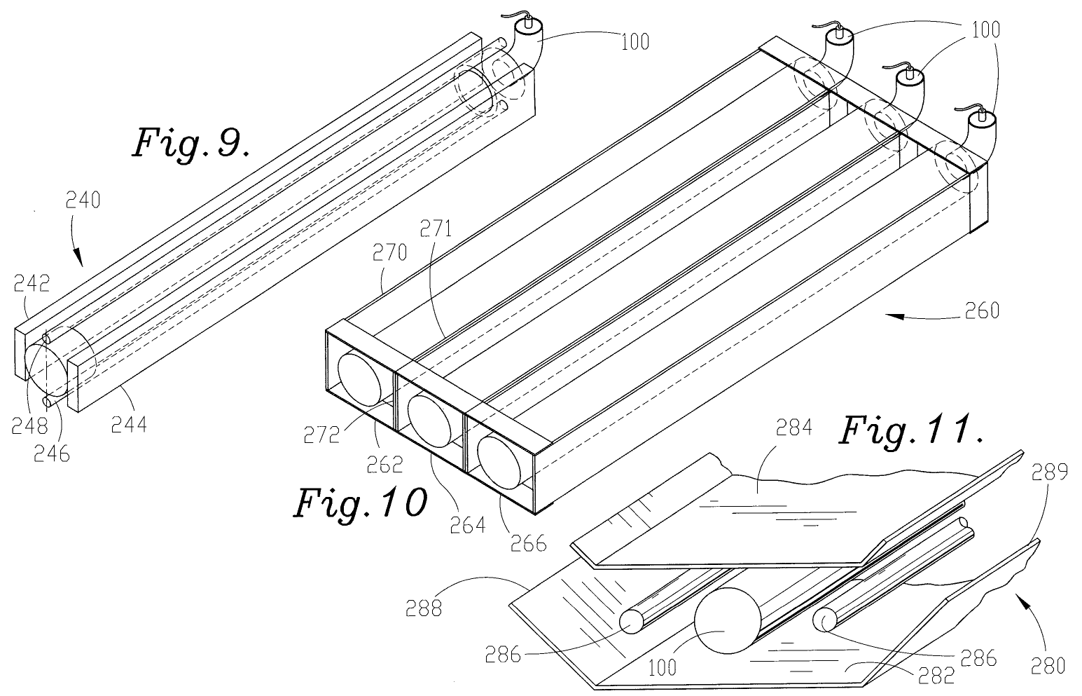

FIGS. 9 through 11 show various embodiments of channel layouts which may be utilized in connection with the instant invention to divert and/or capture a flowing fluid within an isolated electric field. The channel (or diverter) layouts illustrated in FIGS. 9 through 11 include charged electrodes having a tubular shape. It will be appreciated that either a tubular charged electrode, or a flat plate electrode or any other shape of charged electrode, whether or not a multi-layered electrode as described in connection with the instant invention, can be utilized in connection with the channel layouts shown in FIGS. 9 through 11. Additionally, it will be appreciated that the size and shape of the channel layouts may be altered significantly to allow for utilization in a variety of re-circulating fluid systems and to control electric field intensity and fluid dwell time.

FIG. 9 shows an embodiment of the fluid diverting channel which may be utilized to allow for transverse flow of a fluid across a charged electrode. In FIG. 9, charged tubular electrode 100 is positioned between sidewalls 242 and 244 of channel chamber 240. Walls 242 and 244 are grounded to the power source providing power to electrode 100 to enable the creation of an electric field between charged electrode 100 and grounded walls 242 and 244. Additionally, channel chamber 240 includes grounded rods 246 and 248 located at the top and bottom of channel chamber 240 as it is shown in FIG. 9. Rods 246 and 248 can also be grounded to the power supply along with sidewalls 242 and 244. The inclusion of grounded rods 246 and 248 help in shaping the electric field such that it surrounds the entirety, or as much as possible, of charged electrode 100. The embodiment of the channel chamber illustrated in FIG. 9 can be utilized as a single chamber or as multiple chambers placed adjacent to or stacked upon one another. The design of channel chamber 240 allows the fluid to flow between grounded walls 242 and 244 by entering and exiting on the open ends created between the grounded rods 246 and 248 and the walls 242 and 244. Additional walls (not shown) can be included on either end of chamber 240 to fully enclose the charged electrode within the grounded walls and to force all water to enter chamber 240 from a single direction.

FIG. 10 illustrates an embodiment of the fluid diverting channel in which longitudinal flow across the charged electrodes is desired. FIG. 10 shows three individual chambers containing charged electrodes connected together to form a single channel, 260. Channel 260 shown in FIG. 10 includes three individual chambers, 262, 264 and 266. Chamber 262 includes side walls 270 and 271 surrounding the charged electrode and bottom wall 272. Additionally, chamber 262 can include a top wall (not shown) that is opposed to bottom wall 272. Sidewalls 270 and 271 along with bottom wall 272 and the top wall (not shown) are all grounded to the power source providing power to the charged electrode contained within chamber 262 to create an electric field between charged electrode 100 and the grounded chamber walls. Chambers 264 and 266 are identical to chamber 262 and can be stacked beside chamber 262 as shown in FIG. 10 and/or on top of chamber 262 as is shown in the channel embodiment of FIG. 13. Additionally, as many individual chambers can be stacked side by side and/or on top of each other to create a channel of virtually any shape and dimension necessary.

FIG. 11 shows yet another embodiment of a drop in channel of the instant invention. The embodiment of channel 280, shown in FIG. 11, is designed to retain water within the channel at all times, even when no fluid is being circulated within the cooling tower or other fluid re-circulating system. The retention of fluid within channel 280 allows the outer surface of electrode 100 to remain submerged at all times, which is beneficial to the performance and durability of the charged electrode by reducing damage caused from freeze and thaw cycles, and by continuously coating the electrode with fluid at times when the tank is dry. Channel 280 includes a bottom trough 282 having raised sides to retain fluid within the trough (trough ends not shown). Charged electrode 100 is contained within trough 282 and surrounded by rods 286 and top plate 284. Trough 282, rods 286 and top plate 284 are all grounded to the power source that provides power to charged electrode 100 so that an electric field is created between charged electrode 100 and the grounded members. Top plate 284 and rods 286 are positioned to control the shape and intensity of the electric field. When a fluid is being circulated through the system in which drop in channel 280 has been positioned, the fluid will flow over trough edge 288 and into trough 282 past charged electrode 100. When enough fluid has built up in trough 282, the flow of newly entering fluid into trough at side 288 will force the fluid within trough 282 over side 289. It may be beneficial to design trough 282 such that side 289 is shorter than side 288 to prevent back-flow over side 288. Additionally, it will be appreciated that the dimensions of all the walls of trough 282 can be varied to control the flow of fluid into, within, and out of the trough.

It is understood that any of the channel arrangements described above, in connection with FIGS. 9 through 11 and 13, could be used alone or in combination with a separate diverter. Additionally, it is understood that the size and shape of the channels and the channel walls could be varied and arranged in virtually any manner to accommodate the size and shape of virtually any drop in location, and to control electric field intensity, field shape, fluid flow, fluid volume and dwell time. Any of the channels described above could be used in a situation where a fluid is flowing either horizontally or vertically depending upon the needs at the point of installation. Additionally, any type, size or shape of electrode can be accommodated by making simple modifications to the embodiments described above.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive electrostatic fluid treatment apparatus and method is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. An electrostatic fluid treatment apparatus for treating a fluid flowing through a system, the apparatus comprising:
a first charged electrode; and
a ground electrode electrically and mechanically connected to the first charged electrode, the ground electrode including a fluid channel for directing at least a portion of the fluid between the ground electrode and the first charged electrode.

2. The electrostatic fluid treatment apparatus as set forth in claim 1, wherein the system is a cooling system, and the apparatus is located within a fluid tank of a cooling tower.

3. The electrostatic fluid treatment apparatus as set forth in claim 1, further comprising a second charged electrode which is electrically isolated from the first charged electrode.

4. The electrostatic fluid treatment apparatus as set forth in claim 3, wherein the fluid channel electrically isolates the second charged electrode from the first charged electrode.

5. The electrostatic fluid treatment apparatus as set forth in claim 1, wherein the fluid channel includes a trough for holding the at least a portion of the fluid within the fluid channel.

6. The electrostatic fluid treatment apparatus as set forth in claim 1, wherein the first charged electrode includes:
a structural first layer;
a conductive second layer bonded to the structural first layer and connected to a power source; and
an insulating third layer bonded to the conductive second layer and having a generally high dielectric constant.

7. The electrostatic fluid treatment apparatus as set forth in claim 6, wherein the power source provides the conductive second layer with an electric charge of at least approximately thirty thousand volts.

8. An electrostatic fluid treatment apparatus for treating a fluid circulating in a cooling system, the apparatus comprising:
a first charged electrode including:
a structural first layer,
a conductive second layer bonded to the structural first layer and connected to a power source, the power source providing the conductive second layer with an electric charge of at least approximately thirty thousand volts, and
an insulating third layer bonded to the conductive second layer and having a generally high dielectric constant; and
a ground electrode electrically and mechanically connected to the first charged electrode, the ground electrode including a fluid channel for directing at least a portion of the fluid between the ground electrode and the first charged electrode.

9. A method of treating a fluid flowing in a system, the method comprising the steps of:
providing a fluid channel;
mounting a charged electrode in the fluid channel;
incorporating the fluid channel into the system;
diverting at least a portion of the fluid with the fluid channel; and
directing the diverted fluid past the charged electrode to expose the diverted fluid to an electric field.

10. The method as set forth in claim 9, wherein the system is a cooling system, and the apparatus is located a cooling tower.

11. The method as set forth in claim 10, wherein the fluid channel is located on the floor of the cooling tower.

12. The method as set forth in claim 11, wherein the fluid channel includes a fluid entrance portion and a fluid exit portion, and the fluid exit portion is located proximate to a fluid drain of the cooling tower.

13. The method as set forth in claim 9, wherein the fluid channel includes a ground electrode for electrical cooperation with the charged electrode to produce the electric field.

14. A method of treating a fluid circulating in a cooling system, the method comprising the steps of:
providing a fluid channel, the fluid channel including a fluid entrance portion and a fluid exit portion,
mounting a charged electrode in the fluid channel;
incorporating the fluid channel containing the charged electrode into a fluid cooling tower;
allowing the fluid channel to act as a ground electrode for the charged electrode;
diverting at least a portion of the fluid with the fluid channel; and
directing the diverted fluid past the charged electrode to expose the diverted fluid to an electric field produced by the ground electrode and the charged electrode.

15. The method as set forth in claim 14, wherein the fluid channel is placed on the floor of the cooling tower.

16. The method as set forth in claim 15, wherein the fluid exit portion of the fluid channel is located proximate to a water drain of the cooling tower.

17. A method of treating a fluid flowing in a system, the method comprising the steps of:
creating a first isolated electric field within a holding tank with the electrostatic fluid treatment apparatus; and
diverting at least a portion of the fluid through the first isolated electric field before the at least a portion of the fluid exits the holding tank.

18. The method as set forth in claim 17, wherein the first isolated electric field is created by a charged electrode located proximate to a ground electrode, and wherein the ground electrode forms a fluid channel to divert the at least a portion of the fluid.

19. The method as set forth in claim 17, further including a second isolated electric field located adjacent to the first isolated electric field.

20. The method as set forth in claim 17, wherein the first isolated electric field is located proximate to a drain of the holding tank.
